(19) United States
(12) Patent Application Publication
(10) Pub. No.: US 2005/0287508 A1
(43) Pub. Date: Dec. 29, 2005

(54) Multi-institution scheduling system

(75) Inventors: Michael Johnson, Saint Paul, MN (US); Erik Hanson, West Saint Paul, MN (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Headwaters Software, Inc.

(21) Appl. No.: 10/876,215

(22) Filed: Jun. 24, 2004

(51) Int. Cl. G09B 3/00

(52) U.S. Cl. 434/350

(57) ABSTRACT

A multi-institution scheduling system comprises an administration component adapted for establishing parameters for a first program in the multi-institution scheduling system, the parameters including at least one other program that can share shifts with the first program. The multi-institution scheduling system comprises a scheduling component adapted for creating a shift for the first program, including designating whether the at least one other program has access to the shift for scheduling.

### BACKGROUND

The present invention relates to a multi-institution scheduling system. More particularly, in one embodiment, the present invention relates to a multi-institution scheduling system for scheduling students from multiple medical services training schools to healthcare internship shifts at multiple healthcare institutions.

Students in the medical fields are usually required as part of their training to complete clinical rotations or internships. The clinical rotations or internships can be performed at any number of healthcare service providers. Each student from a given school or other training program may have multiple institutions where they spend time (typically designated as “shifts”) during their rotations or internships. These locations can include hospitals, clinics, laboratories, ambulance services, nursing homes, or any other healthcare-related institution. In addition, there are multiple training programs or schools that can schedule students for shifts at the various institutions. Scheduling students for shifts at the various institutions can be a very time consuming task requiring multiple communications between instructors, students, and schedulers or coordinators at the various institutions.

Typically the scheduling process is started by schedulers or coordinators at the various institutions sending lists of available shifts to all the training programs or schools eligible to schedule students to those shifts. The students then select desired shifts from the list or the instructors assign the shifts to their students. The list of scheduled shifts is then returned to the issuing institution. If there are any unfilled shifts on the list, the institution may find students from other training programs or schools to fill those shifts. In addition, any changes to scheduled shifts, such as cancellations, start times, end times, etc., must be coordinated between the issuing institution, the instructors, and the students, leading to more communications between the institutions, instructors, and students. The process is also prone to errors due to the difficulty in coordinating between the parties.

### SUMMARY

One embodiment of the invention provides a multi-institution scheduling system. The multi-institution scheduling system comprises an administration component adapted for establishing parameters for a first program in the multi-institution scheduling system, the parameters including at least one other program that can share shifts with the first program. The multi-institution scheduling system comprises a scheduling component adapted for creating a shift for the first program, including designating whether the at least one other program has access to the shift for scheduling.

### BRIEF DESCRIPTION OF THE DRAWINGS

FIG. 1 is a block diagram illustrating one embodiment of a multi-institution scheduling system.

FIG. 2 is a block diagram illustrating one embodiment of a computer system for a multi-institution scheduler.

FIG. 3 is a block diagram illustrating one embodiment of a computing device for communicating with the multi-institution scheduler.

FIG. 4 is a schematic diagram illustrating one embodiment of the multi-institution scheduler.

FIG. 5 is a diagram illustrating one embodiment of a database for the multi-institution scheduler.

FIG. 6 is a diagram illustrating one embodiment of a graphical user interface for the multi-institution scheduler.

FIG. 7 is a flow diagram illustrating one embodiment of a method for setting up a program in the multi-institution scheduler.

FIG. 8 is a flow diagram illustrating one embodiment of a method for creating a shift in the multi-institution scheduler.

FIG. 9 is a flow diagram illustrating one embodiment of a method for an instructor assigning a shift to a student in the multi-institution scheduler.

FIG. 10 is a flow diagram illustrating one embodiment of a method for a student selecting a shift in the multi-institution scheduler.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

The term “program,” as used herein, refers to an institution (i.e., a school or other training facility) that trains students, including in one embodiment, students in the medical fields.

The term “student,” as used herein, refers to a person enrolled in a program, including in one embodiment, a medical training program.

The term “instructor,” as used herein, refers to a person who teaches students or schedules students to shifts.

The term “administrator,” as used herein, refers to a person who oversees the scheduling system.

The term “site,” as used herein, refers to any location where students work shifts, including in one embodiment, healthcare facilities, ambulance services, or other healthcare related facilities where students work to complete clinical rotations or internships.

The term “shared shift,” as used herein, refers to a shift created by a first program, which is available for scheduling to students from the first program and students from at least one other program.

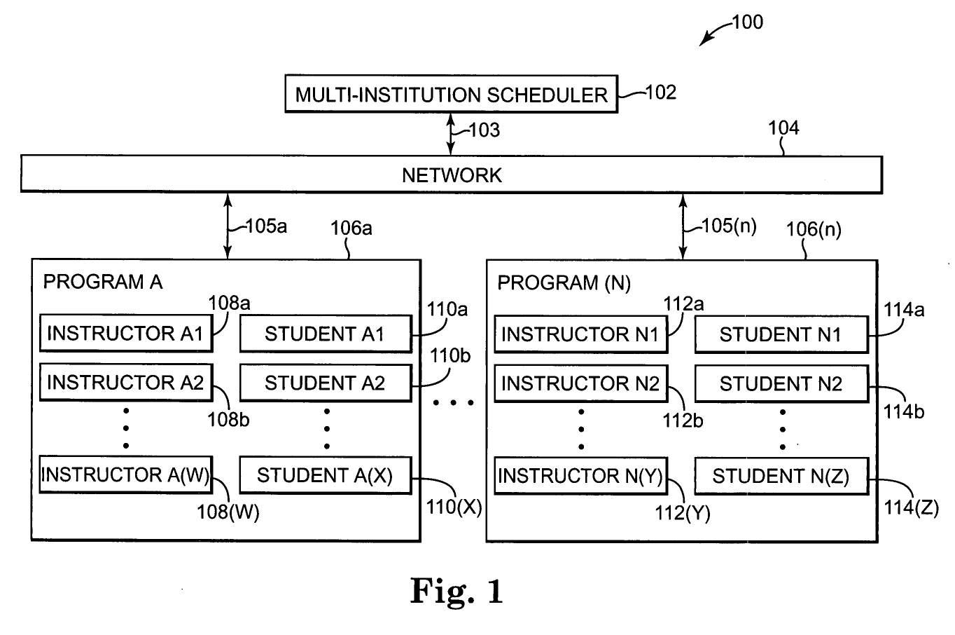

FIG. 1 is a block diagram illustrating one embodiment of a multi-institution scheduling system 100. Multi-institution scheduling system 100 provides a system for scheduling healthcare services students from multiple programs or schools to internship shifts at multiple healthcare sites. Multi-institution scheduling system 100 includes a multi-institution scheduler 102, a network 104, and any suitable number of programs (n), including programs 106a-106(n). Multi-institution scheduler 102 is communicatively coupled to network 104 through communication link 103. Programs 106a-106(n) are communicatively coupled to network 104 through communication links 105a-105(n), respectively. Each program 106a-106(n) is able to use system 100.

Programs 106a-106(n) can each include zero or more instructors and zero or more students, depending on whether the program is a school or other training institution. A program with zero students is a training institution that schedules shifts for students enrolled in other programs.

In one embodiment, each program 106a-106(n) has a number of instructors to teach a number of students enrolled in each program 106a-106(n). Program A 106a includes any suitable number of instructors (w), including instructors 108a-108(w). Program A 106a also includes any suitable number of students (x), including students 110a-110(x). Program (N) 106(n) includes any suitable number of instructors (y), including instructors 112a-112(y). Program (N) 106(n) also includes any suitable number of students (z), including students 114a-114(z). In one embodiment, students within a program are divided into class sections that are assigned to an instructor or instructors in the program. For example, students 110a-110j could be assigned to a first class section, which is assigned to instructor A 108a, and students 110k-110p could be assigned to a second class section, which is assigned to instructor B 108b.

Multi-institutional scheduler 102 is a scheduling system for scheduling students from multiple programs to healthcare internship shifts at multiple sites. The sites can include hospitals, clinics, laboratories, ambulance services, nursing homes, or any other healthcare related site. The shifts include clinical shifts, such as at hospitals and clinics, and field shifts, such as ride along with ambulance services. In one embodiment, a program that creates shifts can share some or all of their created shifts with other programs, such that the students from the other programs can be scheduled for the shared shifts.

Multi-institution scheduler 102 includes an application program that utilizes a central database for storing scheduling data. In addition, multi-institution scheduler 102 includes a graphical user interface (GUI) for receiving data and commands from administrators, instructors, students, and other authorized users of the scheduling system. In one embodiment, multi-institutional scheduler 102 is implemented on a web server and provides a website based GUI that can be accessed by administrators, instructors, students, and other authorized users using any suitable web browser.

Network 104 is a communication network for providing a communication link between multi-institution scheduler 102 and programs 106a-106(n). In one embodiment, network 104 is the Internet. In other embodiments, network 104 is any suitable network capable of providing a communication link between multi-institution scheduler 102 and programs 106a-106(n).

Programs 106a-106(n) are each associated with a school or other training institution for healthcare services providers. The schools can include emergency medical technician (EMT) schools, paramedic schools, first responder schools, nursing schools, medical schools, or any other healthcare services provider related schools. The other training institutions can include hospitals, clinics, ambulance services, or any other healthcare services provider related institution that may or may not have its own students. The instructors, such as 108a-108(w) and 112a-112(y), and the students, such as 110a-110(x) and 114a-114(z), access multi-institution scheduler 102 through network 104.

Both the instructors and students in each program communicate with multi-institution scheduler 102 through network 104 using a computing device linked to network 104. The network connection between the computing device and network 104 can be permanent, such as a cable modem, digital subscriber line (DSL), or other direct connection, or temporary, such as a dial-up connection or wireless connection. The computing device can be a personal computer (PC), a laptop computer, or any device capable of communicating with multi-institution scheduler 102 through network 104. In one embodiment, the computing device is configured to communicate with multi-institution scheduler 102 through a web browser.

Administrators, instructors, students, and other authorized users access multi-institution scheduler 102 to perform a variety of functions. Administrators access multi-institution scheduler 102 to set up programs, including the instructors and students associated with the programs, configure multi-institution scheduler 102, and perform other administrative functions. Instructors access multi-institution scheduler 102 to view the shift schedule, create shifts, edit shifts, delete shifts, and assign shifts to their students. Students access multi-institution scheduler 102 to view the shift schedule, select shifts, drop shifts, and trade shifts with other students.

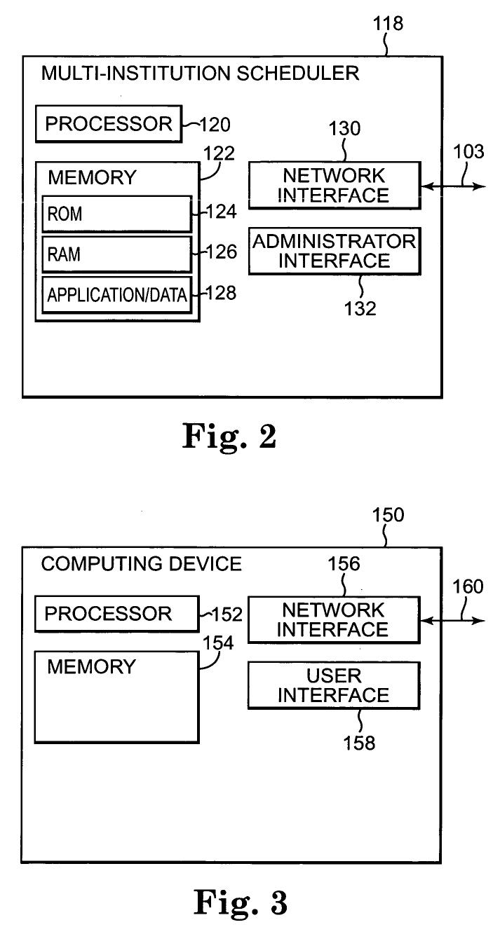

FIG. 2 is a block diagram illustrating one embodiment of a computer system 118 for implementing multi-institution scheduler 102 (FIG. 1). Computer system 118 includes a processor 120, a memory 122, a network interface 130, and an administrator interface 132. Memory 122 includes a read only memory (ROM) 124, a random access memory (RAM) 126, and an application/data memory 128. Network interface 130 is communicatively coupled to network 104 (FIG. 1) through communication link 103.

Computer system 118 executes an application program for implementing multi-institution scheduler 102 (FIG. 1). The application program is loaded from application/data memory 128 or any other computer readable medium. Processor 120 executes commands and instructions for implementing multi-institution scheduler 102. In one embodiment, ROM 124 stores the operating system for computer system 118 and RAM 126 temporarily stores application data and instructions for implementing multi-institution scheduler 102. Network interface 130 communicates with network 104 (FIG. 1) for passing data between computer system 118 and instructors and students of programs 106a-106(n). Administrator interface 132 provides an interface to computer system 118 for administrators to configure multi-institution scheduler 102. In one embodiment, administrator interface 132 includes a keyboard, a monitor, a mouse, and/or any other suitable input or output device. In one embodiment, computer system 118 is a computer server, such as a web server configured to provide a website as an interface to multi-institution scheduler 102 for instructors, students, and other authorized users.

Memory 122 can include main memory, such as a random access memory (RAM) 126, or other dynamic storage device. Memory 122 can also include a static storage device for application/data memory 128, such as a magnetic disk or optical disk. Memory 122 stores information and instructions to be executed by processor 120. In addition, memory 122 stores data for multi-institution scheduler 102. One or more processors in a multi-processor arrangement can also be employed to execute a sequence of instructions contained in memory 122. In other embodiments, hardwired circuitry can be used in place of or in combination with software instructions to implement multi-institution scheduler 102 (FIG. 1). Thus, embodiments of multi-institution scheduler 102 are not limited to any specific combination of hardware circuitry and software.

The term “computer readable medium,” as used herein, refers to any medium that participates in providing instructions to processor 120 for execution. Such a medium can take many forms, including but not limited to, non-volatile media, volatile media, and transmission media. Non-volatile media include, for example, optical or magnetic disks. Volatile media includes dynamic memory. Transition media include coaxial cables, copper wire, and fiber optics. Transmission media can also take the form of acoustic or light waves, such as those generated during radio frequency (RF) and infrared (IR) data communications. Common forms of computer readable media include, for example, a floppy disk, a flexible disk, a hard disk, magnetic tape, any other magnetic mediums, a CD-ROM, DVD, any other optical medium, punch cards, paper tape, any other physical medium with patterns of holes, a RAM, a programmable read-only memory (PROM), an electrical programmable read-only memory (EPROM), an electrically erasable programmable read-only memory (EEPROM), any other memory chip or cartridge, or any other medium from which a computer can read.

FIG. 3 is a block diagram illustrating one embodiment of a computing device for communicating through network 104 (FIG. 1) with multi-institution scheduler 102 (FIG. 1). Computing device 150 includes a processor 152, a memory 154, a network interface 156, and a user interface 158. Network interface 156 is communicatively coupled to network 104 through communication link 160. Any number of computing devices 150 can be used by instructors, students, and other authorized users of multi-institution scheduler 102.

Processor 152 executes instructions from memory 154 for accessing multi-institution scheduler 102. Network interface 156 communicates with multi-institution scheduler 102 through network 104 for accessing multi-institution scheduler 102. User interface 158 provides an interface to multi-institution scheduler 102 for instructors, students, and other authorized users. User interface 158 includes a monitor, a keyboard, a mouse, or any other suitable input or output device for interacting with multi-institution scheduler 102.

Computing devices 150 are used by instructors, students, and other authorized users to communicate with multi-institution scheduler 102 to create, edit, delete, assign, select, drop, trade, etc., shifts in multi-institution scheduler 102. In one embodiment, computing device 150 is a personal computer configured to run a web browser to access a website provided by multi-institution scheduler 102.

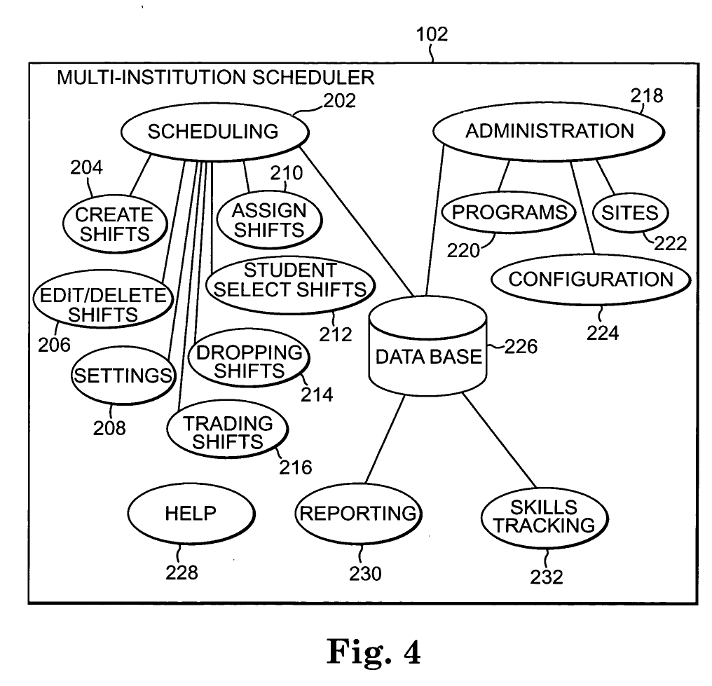

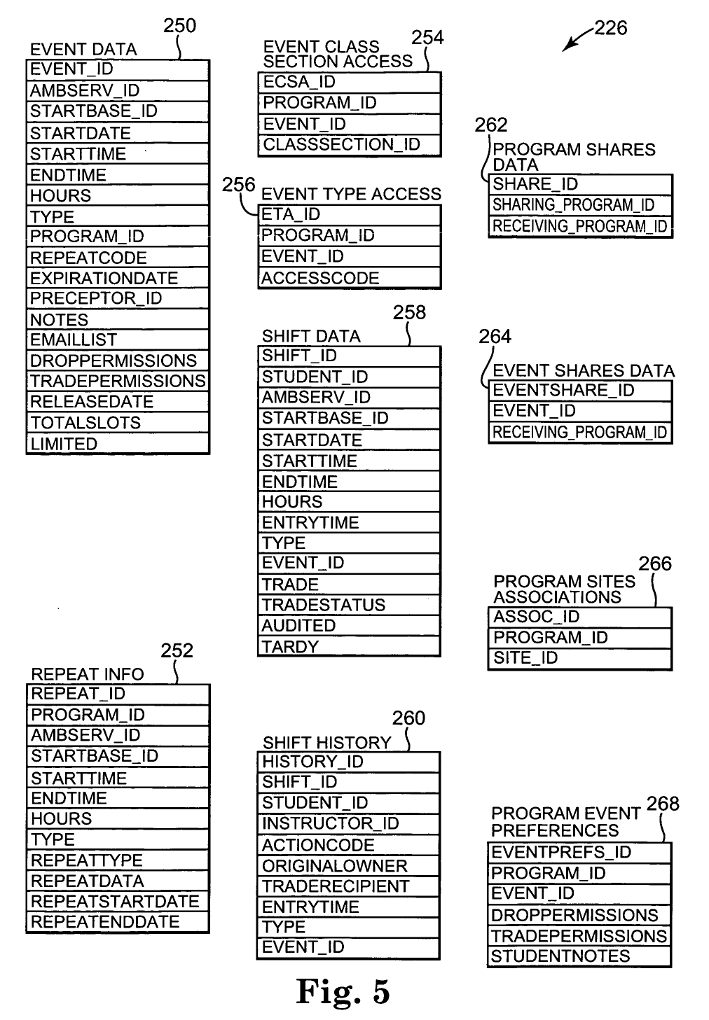

FIG. 4 is a schematic diagram illustrating one embodiment of multi-institution scheduler 102. Multi-institution scheduler 102 includes a scheduling component 202, an administration component 218, a database 226, a help component 228, a reporting component 230, and a skills tracking component 232. Scheduling component 202, administration component 218, reporting component 230, and skills tracking component 232 read data from and write data to database 226.

In one embodiment, scheduling component 202 includes a create shifts subcomponent 204, an edit/delete shifts subcomponent 206, a settings subcomponent 208, an assign shifts subcomponent 210, a student select shifts subcomponent 212, a dropping shifts subcomponent 214, and a trading shifts subcomponent 216. In one embodiment, administration component 218 includes a programs subcomponent 220, a sites subcomponent 222, and a configuration subcomponent 224.

Scheduling component 202, in one embodiment, is a software module that provides for the scheduling of healthcare internship shifts for students of multiple programs at multiple healthcare sites. Scheduling component 202 includes a graphical user interface (GUI) for instructors, students, and other authorized users for accessing the following functions: creating, editing, deleting, selecting, assigning, dropping, and trading shifts. Instructors, students, and other authorized users access to the functions can be limited and can vary between instructors, students, and other authorized users.

Create shifts subcomponent 204, in one embodiment, is a software sub-module that provides for the creating of healthcare internship shifts. Create shifts subcomponent 204 includes a GUI for instructors or other authorized users to create shifts for which students can be scheduled.

Assign shifts subcomponent 210, in one embodiment, is a software sub-module that provides for the assignment of shifts to students by instructors. Assign shifts subcomponent 210 includes a GUI for instructors or other authorized users to assign shifts to students.

Edit/delete shifts subcomponent 206, in one embodiment, is a software sub-module that provides for the editing and deleting of shifts by instructors and other authorized users. Edit/delete shifts subcomponent 206 includes a GUI for instructors and other authorized users to edit and delete shifts.

Student select shifts subcomponent 212, in one embodiment, is a software sub-module that provides for the scheduling of shifts by students. Student select shift subcomponent 212 includes a GUI for students to select available shifts for their schedules.

Dropping shifts subcomponent 214, in one embodiment, is a software sub-module that provides for the dropping of shifts by students. Dropping shifts subcomponent 214 includes a GUI for students to drop shifts for which they have been scheduled.

Trading shifts subcomponent 216, in one embodiment, is a software sub-module that provides for the trading of shifts by students. Trading shifts subcomponent 216 includes a GUI for students to trade their scheduled shifts with other students.

Settings subcomponent 208, in one embodiment, is a software sub-module that provides for the configuration of setting for scheduling component 202 by instructors and other authorized users. Setting subcomponent 208 includes a GUI for instructors and other authorized users to configure the settings for scheduling component 202.

Administration component 218, in one embodiment, is a software module that provides for administering programs and sites and configuring multi-institution scheduler 102. Administration component 218 includes a GUI for administrators and other authorized users to administer programs and sites and configure multi-institution scheduler 102.

Programs subcomponent 220, in one embodiment, is a software sub-module that provides for setting up and maintaining a program in multi-institution scheduler 102. Programs subcomponent 220 includes a GUI for administrators and other authorized users to set up and maintain programs in multi-institution scheduler 102.

Sites subcomponent 222, in one embodiment, is a software sub-module that provides for setting up and maintaining sites in multi-institution scheduler 102, including approving the association of sites and programs. Sites subcomponent 222 includes a GUI for administrators and other authorized users to set up and maintain sites in multi-institution scheduler 102.

Configuration subcomponent 224, in one embodiment, is a software sub-module that provides for configuring multi-institution scheduler 102. Configuration subcomponent 224 includes a GUI for administrators for configuring multi-institution scheduler 102.

Database 226 provides the data tables used for storing data for implementing multi-institution scheduler 102. Database 226 is accessed for reading and writing data by scheduling component 202, administration component 218, reporting component 230, and skills tracking component 232. In one embodiment, database 226 is a relational-database compatible with structured query language (SQL).

Help component 228 provides instructions to administrators, instructors, students, and other authorized users for using multi-institution scheduler 102. Reporting component 230 provides for the generation of reports related to many aspects of multi-institution scheduler 102. Skills tracking component 232 provides for the tracking of students' progress in learning the medical skills taught during their internship shifts.

In one embodiment, the GUIs of scheduling component 202 and its subcomponents 204-216, administration component 218 and its subcomponents 220-224, reporting component 230, and skills tracking component 232 are organized into a website accessible by any suitable web browser. Each of the GUIs for the components comprise one or more web pages in the website. Administrators, instructors, students, and other authorized users access the website to interact with the components to perform the various functions of multi-institution scheduler 102. In other embodiments, the GUIs of scheduling component 202 and its subcomponents 204-216, administration component 218 and its subcomponents 220-224, reporting component 230, and skills tracking component 232 are organized into any suitable application program. Administrators, instructors, students, and other authorized users access the application program to interact with the components to perform the various functions of multi-institution scheduler 102.

FIG. 5 is a diagram illustrating one embodiment of database 226 of multi-institution scheduler 102. Database 226 includes Event Data Table 250, Repeat Info Table 252, Event Class Section Access Table 254, Event Type Access Table 256, Shift Data Table 258, Shift History Table 260, Program Shares Data Table 262, Event Shares Data Table 264, Program Sites Associations Table 266, and Program Event Preferences Table 268. With additional reference to FIG. 4, the tables store data for scheduling component 202, creating shifts subcomponent 204, edit/delete shifts subcomponent 206, assign shifts subcomponent 210, student select shifts subcomponent 212, dropping shifts subcomponent 214, and trading shifts subcomponent 216. Other tables (not shown) are used to store data for administration component 218, skill tracking component 232, and reporting component 230.

Event Data Table 250 is linked to Event Class Section Access Table 254, Event Type Access Table 256, Shift Data Table 258, Shift History Table 260, Event Shares Data Table 264, and Program Event Preferences Table 268 through the Event_ID field. Event Data Table 250 is linked to Repeat Info Table 252 through the Repeat_id field and the RepeatCode field. Event Data Table 250 is linked to Repeat Info Table 252 and Shift Data Table 258 through the StartBase_id field. Event Data Table 250 is linked to Repeat Info Table 252, Event Class Section Access Table 254, Event Type Access Table 256, Program Sites Associations Table 266, and Program Event Preferences Table 268 through the Program_id field. Shift Data Table 258 is linked to Shift History Table 260 through the Shift_id field. Program Shares Data Table 262 is linked to Event Shares Data Table 264 through the Receiving_Program_id field.

Event Data Table 250 stores data about shifts independent of whether students are scheduled for the shifts. Each shift is represented in the table as a separate record. A new shift record is created in the table each time a new shift is entered into multi-institution scheduler 102 by an instructor or other authorized user. Records in the table are created, edited, and deleted based on inputs from administrators, instructors, and other authorized users to multi-institution scheduler 102.

Event Data Table 250 includes, in one embodiment, the following fields: Event_id, AmbServ_id, StartBase_id, StartDate, StartTime, EndTime, Hours, Type, Program_id, RepeatCode, ExpirationDate, Preceptor_id, Notes, EmailList, DropPermissions, TradePermissions, ReleaseDate, TotalSlots, and Limited.

The Event_id field stores a unique identifier indicating a shift. The AmbServe_id field stores a unique identifier of the medical facility associated with the shift. The StartBase_id field stores a value indicating the starting base associated with the shift. The StartDate field stores the start date for the associated shift. The StartTime field stores the start time for the associated shift. The EndTime field stores the end time for the associated shift. The Hours field stores a value indicating the length of the associated shift in hours.

The Type field stores a value indicating the type of the associated shift, such as a field shift or a clinical shift. The Program_id field stores a unique identifier indicating the program that created or owns the shift. The RepeatCode field stores a unique identifier indicating the Repeat Info Table record for the associated shift. The ExpirationDate field stores a date after which a student cannot select the associated shift.

The Preceptor_id field stores a unique identifier indicating the preceptor for the associated shift. The Notes field stores any notes associated with the shift. The EmailList field stores a list of email addresses of people who will receive notifications of any changes made to the associated shift. The DropPermissions field stores a value indicating the permissions the students have on dropping the associated shift. The TradePermissions field stores a value indicating the permissions the students have on trading the associated shift.

The ReleaseDate field stores the date on which the associated shift will become available for selection by a student. The TotalSlots field stores a value indicating the total number of slots available for the associated shift. The Limited field stores a value indicating whether the associated shift is limited to particular students. If the associated shift is limited to particular students, detailed limiting information for the associated shift is stored in Event Class Section Access Table 254, Event Type Access Table 256, and/or Program Event Preferences Table 268.

Repeat Info Table 252 stores data for automatically generating multiple shifts in Event Data Table 250 based on repeating criteria entered by an instructor or other authorized user. Each group of repeating shifts have a record in the table. The record is linked to all the shifts in Event Data Table 250 created in response to the repeating criteria. When one of the shifts is updated, all of the shifts linked by the repeating shift criteria can be updated as well. For example, if the repeating shift was entered as starting at 8 AM and is later changed to starting at 9 AM, all of the shifts based on the repeating criteria can be updated to starting at 9 AM.

In one embodiment, an instructor or other authorized user has four options to select from for entering repeated shifts. The first option is the shift occurs only once. The second option is to enter information about how often (daily, weekly, monthly, etc.) the shift repeats and the starting and ending dates for the repeating shift. The third option, for a shift that repeats weekly, is to enter the specific days (Sunday through Saturday) the shift repeats and the starting and ending dates for the repeating shift. The fourth option is to select the specific dates the shift repeats during the year. Records in the table are created, edited, and deleted based on inputs from administrators, instructors, and other authorized users to multi-institution scheduler 102.

Repeat Info Table 252 includes, in one embodiment, the following fields: Repeat_id, Program_id, AmbServ_id, StartBase_id, StartTime, EndTime, Hours, Type, RepeatType, RepeatData, RepeatStartDate, and RepeatEndDate. The Repeat_id field stores a unique identifier indicating a repeating shift record. The Program_id, AmbServ_id, StartBase_id, StartTime, EndTime, Hours, and Type fields are similar to the fields of the same names described above with reference to Event Data Table 250. The RepeatType field stores a value indicating which of the four repeating shift options is selected. The RepeatData field stores a value indicating when the shift repeats. The RepeatStartDate field stores a start date for the repeating shift. The RepeatEndDate field stores an end date for the repeating shift.

Event Class Section Access Table 254 stores data indicating which program class sections have access to specified shifts. Each record in the table associates a program and class section to a shift. Records in the table are created, edited, and deleted based on inputs from administrators, instructors, and other authorized users to multi-institution scheduler 102.

Event Class Section Access Table 254 includes, in one embodiment, the following fields: ECSA_id, Program_id, Event_id, and ClassSection_id. The ECSA_id stores a unique identifier indicating an Event Class Section Access Table 254 record. The Program_id and Event_id fields are similar to the fields of the same names as previously described in reference to Event Data Table 250. The ClassSection_id field stores a unique identifier indicating a class section to which the associated shift is limited.

Event Type Access Table 256 stores data indicating student criteria required for selecting or being assigned to specified shifts. Each record in the table associates a shift to a student type, such as the student is an EMT basic student or nursing student. In one embodiment, students are assigned accounts for accessing multi-institution scheduler 102 based on the type of the training they are receiving. The student account type is used to prevent the students and their instructors from scheduling the students for a shift for which they are not qualified. If an instructor is from the program that created the shift, the instructor is able to override the account type limitation. Records in the table are created, edited, and deleted based on inputs from administrators, instructors, and other authorized users to multi-institution scheduler 102.

Event Type Access Table 256 includes, in one embodiment, the following fields: ETA_id, Program_id, Event_id, and AccessCode. The ETA_id field stores a unique identifier indicating an Event Type Access Table 256 record. The Program_id and Event_id fields are similar to the fields of the same names as previously described in reference to Event Data Table 250. The AccessCode field stores an access code for the associated program and shift indicating the student account required to select or be assigned to the associated shift.

Shift Data Table 258 stores data for shifts that have been selected by students or assigned to students. Each record in the table stores data relating to a single shift. Records in the table are created, edited, and deleted based on inputs from administrators, instructors, students, and other authorized users to multi-institution scheduler 102.

Shift Data Table 258 includes, in one embodiment, the following fields: Shift_id, Student_id, AmbServ_id, StartBase_id, StartDate, StartTime, EndTime, Hours, EntryTime, Type, Event_id, Trade, TradeStatus, Audited, and Tardy. The AmbServ_id, StartBase_id, StartDate, StartTime, EndTime, Hours, Type, and Event_id fields are similar to the fields of the same names as previously described in reference to Event Data Table 250.

The Shift_id field is a unique identifier indicating a unique shift record in the table for a shift that has been selected by a student or assigned to a student. The Student_id field stores a unique identifier of the student associated with the shift. The EntryTime field stores the time the associated shift was selected by a student, assigned to a student, or most recently updated. The TradeStatus field stores a value indicating where in the trade or drop process the associated shift currently resides. The Audited field stores a value indicating whether the associated shift was audited. The Tardy field stores a value indicating whether the student was tardy for the associated shift.

Shift History Table 260 stores data relating to the history of a shift. Each time a shift is selected by a student, assigned to a student, traded by a student to another student, or dropped by a student, a record is created in the table to track the modification. Records in the table are created based on inputs from administrators, instructors, students, and other authorized users to multi-institution scheduler 102.

Shift History Table 260 includes, in one embodiment, the following fields: History_id, Shift_id, Student_id, Instructor_id, ActionCode, OriginalOwner, TradeRecipient, EntryTime, Type, and Event_id. The History_id field stores a unique identifier for a Shift History Table 260 record. The Shift_id and Student_id fields are similar to the fields of the same names as previously described in reference to Shift Data Table 258. The Type and Event_id fields are similar to the fields of the same names as previously described in reference to Event Data Table 250.

The Instructor_id field stores a value indicating the instructor associated with the shift. The ActionCode field stores a value indicating the action taken regarding the associated shift. The OriginalOwner field stores a value indicating the student who was first scheduled for the associated shift. The TradeRecipient field stores a value indicating who received the traded shift. The EntryTime field stores a value indicating the time modifications were made to the associated shift.

Program Shares Data Table 262 stores data that associates a program with other programs for sharing shifts. A first program that associates with other programs for sharing shifts can allow students enrolled in the other programs to be scheduled for shifts created by the first program. Each record in the table associates a program sharing shifts to a program receiving the shared shifts for scheduling students. There can be multiple records in the table to associate a single program sharing shifts to multiple programs receiving the shared shifts. Records in the table are created, edited, and deleted based on inputs from administrators, instructors, and other authorized users to multi-institution scheduler 102.

Program Shares Data Table 262 includes, in one embodiment, the following fields: Share_id, Sharing_Program_id, and Receiving_Program_id. Share_id stores a unique identifier indicating a Program Shares Data Table 262 record. The Sharing_Program_id field stores a unique identifier indicating a program that shares its schedule with other programs. The Receiving_Program_id field stores a unique identifier of a program that shares schedules with the associated program that shares its schedule.

Event Shares Data Table 264 stores data that associates a shift to the programs that have access to the shift. Each record in the table associates a shift to a receiving program. There can be multiple records in the table to associate a single shift to multiple receiving programs. Records in the table are created, edited, and deleted based on inputs from administrators, instructors, and other authorized users to multi-institution scheduler 102.

Event Shares Data Table 264 includes, in one embodiment, the following fields: EventShare_id, Event_id, and Receiving_Program_id. The EventShare_id field stores a unique identifier indicating an Event Shares Data Table 264 record. The Event_id field is similar to the field of the same name as previously described in reference to Event Data Table 250. The Receiving_Program_id field stores a unique identifier indicating a program associated with the shared shift.

Program Sites Associations Table 266 stores data associating programs to sites. Each record in the table associates a program to a site. In one embodiment, a program and a site are at the same location, such as a hospital that also has a healthcare training program for students. Records in the table are created, edited, and deleted based on inputs from administrators, instructors, and other authorized users to multi-institution scheduler 102.

Program Sites Associations Table 266 includes, in one embodiment, the following fields: Assoc_id, Program_id, and Site_id. The Assoc_id field stores a unique identifier indicating a Program Sites Associations Table 266 record. The Program_id field is similar to the field of the same name as previously described in reference to Event Data Table 250. The Site_id field stores a unique identifier indicating a site associated with the program.

Program Event Preferences Table 268 stores data relating to requirements of students in a particular program for scheduling a shared shift that was created by another program called the creating program. The creating program sets minimum requirements for all students for scheduling the shift and other programs, called receiving programs, sharing the shift with the creating program can set additional requirements for their own students for scheduling the shift. The additional requirements cannot contradict the minimum requirements set by the creating program, but can include further limitations. For example, the creating program may state that emergency medical technician basic (EMT-B) and paramedic students can be scheduled for the shift. A receiving program may add the additional limitation that only its EMT-B students can be scheduled for the shift. The receiving program, however, would not be allowed to set a requirement that its emergency medical technician intermediate (EMT-I) students can be scheduled for the shift. Records in the table are created, edited, and deleted based on inputs from administrators, instructors, and other authorized users to multi-institution scheduler 102.

Program Event Preferences Table 268 includes, in one embodiment, the following fields: EventPrefs_id, Program_id, Event_id, DropPermissions, TradePermissions, and StudentNotes. The EventPrefs_id field stores a unique identifier indicating a Program Event Preferences Table 268 record. The Program_id, Event_id, DropPermissions, and TradePermissions fields are similar to the fields of the same names as previously described in reference to Event Data Table 250. The StudentNotes field stores notes for students from instructors for the associated Program Event Preferences Table 268 record.

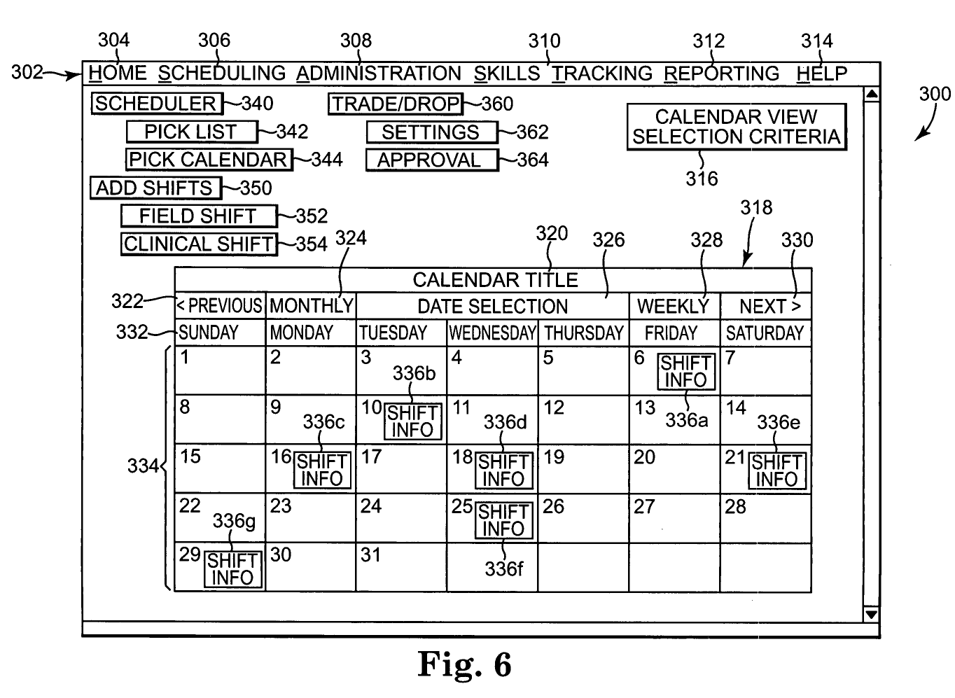

FIG. 6 is a diagram illustrating one embodiment of a graphical user interface (GUI) 300 for multi-institution scheduler 102 (FIG. 1). GUI 300 includes, in one embodiment, main menu 302, sub-menus 340-364, calendar view selection criteria 316, and calendar 318. Main menu 302 includes home selection 304, scheduling selection 306, administration selection 308, skills tracking selection 310, reporting selection 312, and help selection 314. Sub-menus 340-364 include scheduler sub-menu 340, including pick list selection 342 and pick calendar selection 344, add shifts sub-menu 350, including field shift selection 352 and clinical shift selection 354, and trade drop sub-menu 360, including settings selection 362 and approval selection 364.

Calendar 318 includes calendar title bar 320, previous selection button 322, monthly selection button 324, date selection 326, weekly selection button 328, and next selection button 330. In addition, calendar 318 includes days headings 332 and days 334, including shift information 336a-336g.

Instructors, students, and other authorized users use GUI 300 to access portions of multi-institution scheduler 102 (FIG. 1). In main menu 302, home selection 304 is used to access the home page for multi-institution scheduler 102. Scheduling selection 306 is used to access scheduling component 202 (FIG. 4). Administration selection 308 is used to access administration component 218. Skills tracking selection 310 is used to access skills tracking component 232. Reporting selection 312 is used to access reporting component 230. Help selection 314 is used to access help component 228.

Calendar view selection criteria 316 allows an instructor, student, or other authorized user to enter selection criteria to limit the view of calendar 318 to shifts based on the selection criteria. For example, an instructor, student, or other authorized user can enter a specific program, site, or class section into the selection criteria to limit the view of calendar 318. The selection criteria entered at 316 is displayed in calendar title 320. Previous selection button 322 provides a selection for the user to display the previous month. Monthly selection button 324 provides a selection for the user to display a monthly view in calendar 318. Weekly button 328 provides a selection for the user to display a weekly view in calendar 318. Next selection button 330 provides a selection for the user to view the following week or month in calendar 318. Date selection 326 displays the currently selected date for calendar 318.

The days 334 include shift information 336a-336g. Shift information 336 can include the shift start time, end time, duration, class section limitations, preceptor, etc. Calendar 318 is accessed by instructors, students, and other authorized users to view shifts, select shifts, assign shifts to students, edit shifts, create shifts, trade shifts, and drop shifts.

Pick list selection 342 of scheduler sub-menu 340 provides a selection for displaying a shift list view (not shown) in place of calendar view 318. Pick calendar selection 344 provides a selection for displaying calendar view 318. Field shift 352 of add shift sub-menu 350 provides a selection for creating a new field shift. Clinical shift selection 354 provides a selection for creating a new clinical shift. Settings 362 of trade drop sub-menu 360 provides a selection for an instructor to enter trade drop permission settings for a particular shift or all shifts. Approval selection 364 provides a selection for an instructor to approve or reject traded and dropped shifts by students.

GUI 300 can vary depending on whether it is being accessed by an instructor, student, or other authorized user. For example, in one embodiment, add shifts sub-menu 350 is not active for students accessing GUI 300. In addition, shift info 336 displayed may vary depending on the student account type and whether the student has access to the shifts. Other GUI's are accessed from GUI 300. In one embodiment, GUI 300 is a web page on a website for multi-institution scheduler 102 (FIG. 1), and each selection from main menu 302 or sub-menus 340-364 accesses an additional web page specific to that component.

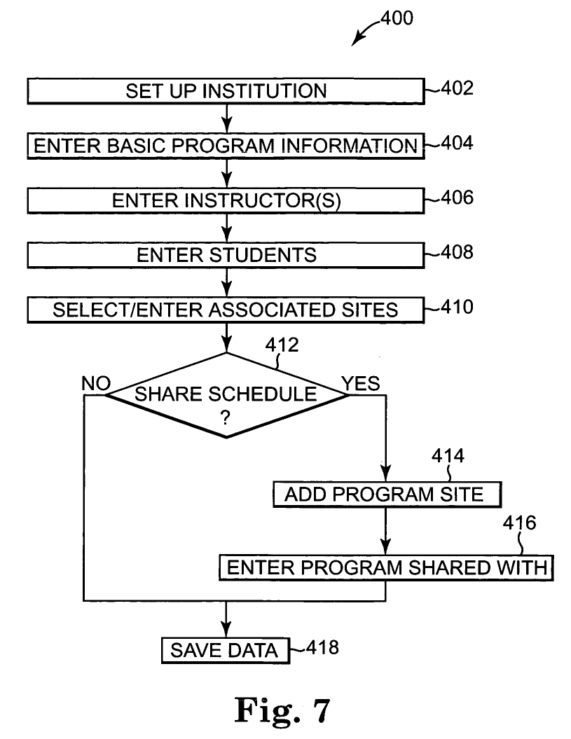

FIG. 7 is a flow diagram illustrating one embodiment of a method 400 for setting up and establishing parameters for a program in multi-institution scheduler 102 (FIG. 1). In one embodiment, method 400 is part of, or performed by, administration component 218 (FIG. 4). At 402, and with additional reference to FIG. 4, an administrator selects the set up institution interface in administration component 218. As part of programs subcomponent 220, at 404, the administrator enters the basic program information into the system. The basic information includes name, address, phone number, and other information relating to the program.

At 406, the administrator enters the list of instructors associated with the program. At 408, the administrator enters the students associated with the program. Also at 408, the administrator can divide the students into class sections and assign each class section to an instructor. At 410, the administrator selects the associated sites for the program from a list of possibilities. If a site is not in the list, the site is created through site subcomponent 222 and then selected.

At 412, the administrator decides whether the shift schedules for the program will be shared with other programs. If the shift schedules will not be shared with other programs, then the entered data is saved in database 226 at 418. If the shift schedules will be shared with other programs, then at 414 the administrator enters the site or sites where the program will share the shift schedules. At 416, the administrator enters the program(s) that will have access to the shared schedule. At 418, the data is saved in database 226. In particular, the data entered at 410 and 414 for associated sites is stored in Program Sites Associations Table 266 and the data entered at 416 is stored in Program Shares Data Table 262.

In one embodiment, an instructor of the program being set up performs method 400 instead of an administrator. In this case, at 410, after an instructor selects or enters a site to associate with the program, an email is generated to inform an administrator of the selection. The administrator then either approves or rejects the association of the site to the program. If the administrator approves the association of the site to the program, the association is stored in Program Sites Associations Table 266 in database 226.

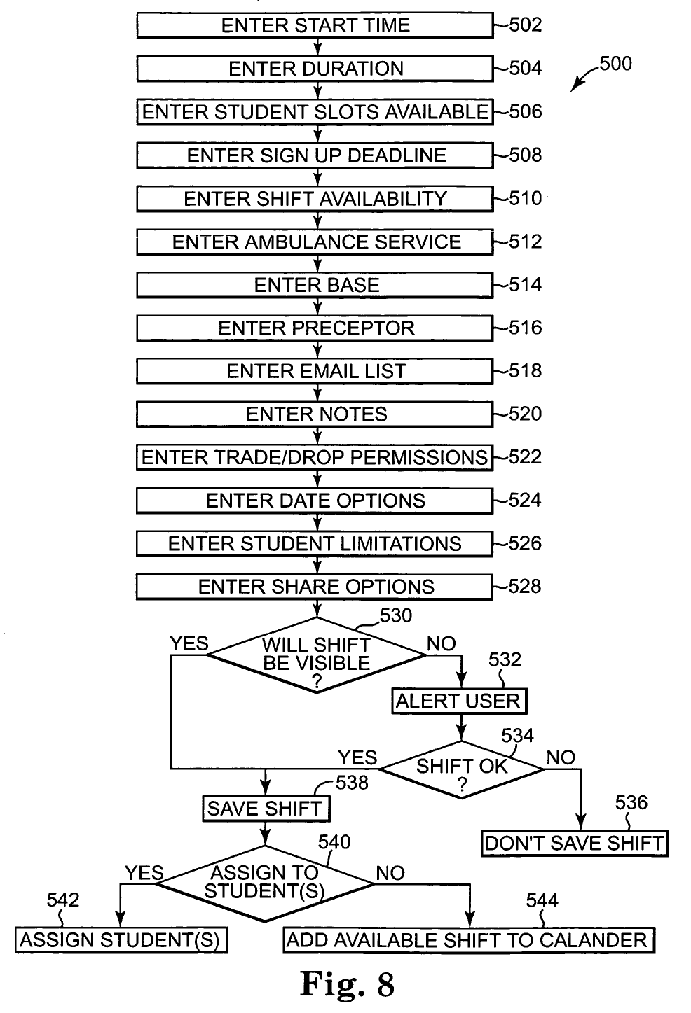

FIG. 8 is a flow diagram illustrating one embodiment of a method 500 for creating a shift relating to an ambulance service institution. In one embodiment, method 500 is part of, or performed by, create shifts subcomponent 204 (FIG. 4). At 502, an instructor or other authorized user enters the start time for the shift. At 504, the instructor enters the duration of the shift in hours. At 506, the instructor enters the number of student slots available. At 508, the instructor enters the student signup deadline, which in one embodiment is provided by entering a number of days or weeks before the shift starts. At 510, the instructor enters the date the shift will become available for student selection.

At 512, the instructor enters the ambulance service institution for the shift. At 514, the instructor enters the base for the ambulance service. At 516, the instructor enters the preceptor for the shift. At 518, the instructor enters an email address list that is used for sending notifications to the addressees informing them about modifications to the shift. At 520, the instructor enters any notes for the shift.

At 522, the instructor enters student trade and drop permissions for the shift. In one embodiment, there are three options for the trade permissions and three options for the drop permissions. The three options for the trade permissions include no trade, trade with permission, which includes the further option of obtaining permission before or after trading, and trade at will. The three options for the drop permission include no drop, drop with permission, and drop at will.

At 524, the instructor enters the date options for the shift. In one embodiment, the instructor has four options as previously described above with respect to Repeat Info Table 252. At 526, the instructor enters the student limitations for the shift, including the student experience level required for the shift. At 528, the instructor enters the share options for the shift, including selecting which programs will have access to the shift.

At 530, create shifts subcomponent 204 (FIG. 4) determines whether the shift will be visible in calendar 318 (FIG. 6) to students accessing multi-institution scheduler 102 (FIG. 4) based on the sign up deadline entered at 508 and the shift availability date entered at 510. If the shift will be visible in calendar 318 to students, then the entered shift data is saved in database 226 at 538. If the shift will not be visible to students, then the instructor is alerted at 532 that the sign up deadline and shift availability date do not allow the shift to ever be visible to students. At 534, the instructor is given the option to accept the shift as is or to go back and edit the fields. If the instructor does not accept the shift, then at 536, the entered shift data is not saved.

If the instructor does accept the shift, then the entered shift data is saved in database 226 (FIG. 4) at 538. In particular, the data entered at 502-522 is stored in Event Data Table 250. The data entered at 524, if a repeating shift, is stored in Repeat Info Table 252. The data entered at 528 is stored in Event Shares Data Table 264. The data entered at 526 is stored in Event Class Section Access Table 254 if it includes class section limitations. The data entered at 526 is stored in Event Type Access Table 256 if it includes event type limitations.

At 540, the instructor is given the option to assign the shift immediately to students. If the instructor decides to assign the shift to students immediately, then at 542 the assign shifts subcomponent 210 is activated to allow the instructor to assign students to the shift. If the instructor decides not to assign the shift to students immediately, then at 544 the shift is added to calendar 318 (FIG. 6) as an available shift.

Entries 502-528 can be entered in any order by the instructor. In addition, edit/delete shifts subcomponent 206 (FIG. 4) uses method 500 for editing a shift except that instead of entering new values for every field, the current values for selected fields are changed.

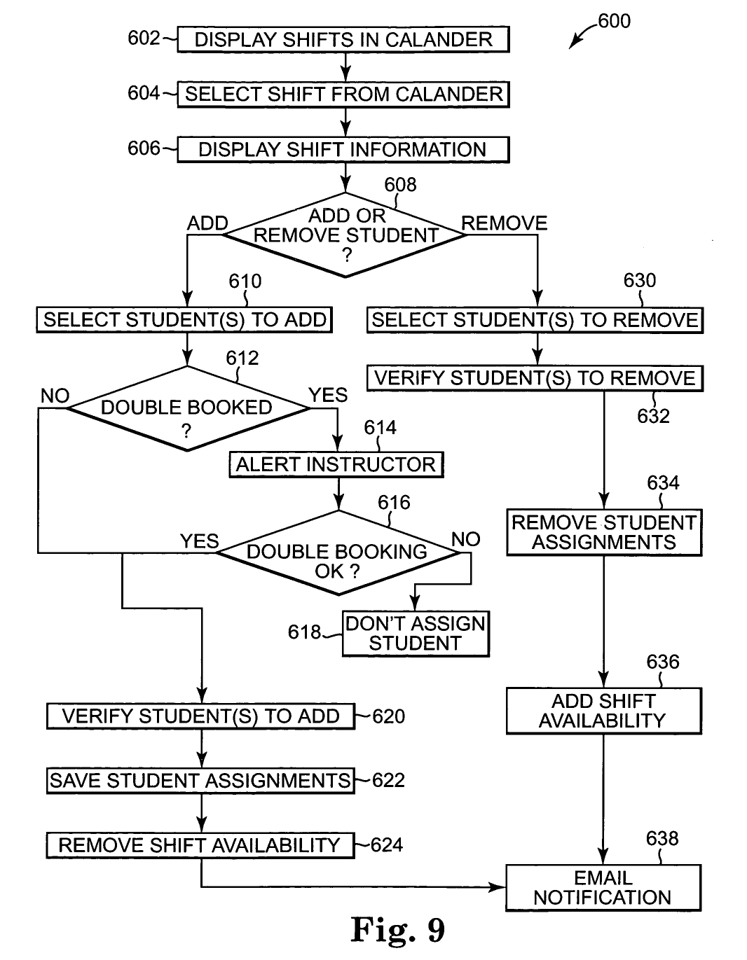

FIG. 9 is a flow diagram illustrating one embodiment of a method 600 for an instructor assigning a shift to a student. In one embodiment, method 600 is part of, or performed by, assign shifts subcomponent 210 (FIG. 4). At 602, scheduling component 202 (FIG. 4) displays the shifts in calendar 318 (FIG. 6) to an instructor. At 604, the instructor selects a shift from calendar 318 to assign to a student or students. At 606, assign shifts subcomponent 210 displays the shift information for the selected shift including, for example, the start date, the start time, the duration, the ambulance service, the base, the preceptor, the open slots, the students signed up for the shift, notes, etc.

At 608, the instructor selects whether to add a student to or remove a student from the shift. To add a student to the shift, the instructor selects students to add at 610. Then at 612, assign shifts subcomponent 210 determines whether the student is scheduled for another shift for the same date and time (i.e. double booked). In some cases, double booking can be valid, such as if a student is scheduled to work at a hospital that also has an ambulance service. The student might work in the emergency room until there is a call for an ambulance and then go with the ambulance for the call.

If the student is double booked, the instructor is alerted at 614 and asked if the double booking is okay. At 616, the instructor answers whether the double booking is okay. If the instructor answers that the double booking is okay or if the student is not double booked, then at 620 the instructor is asked to verify the student(s) to add to the shift. At 622, the student assignments are saved in database 226 and a Shift Data Table 258 record is created or modified. At 624, assign shift subcomponent 210 removes the shift from the schedule of available shifts in calendar 318. If the instructor answers that the double booking is not okay, then at 618, the instructor does not assign the student(s) to the shift.

In one embodiment, the check for double booking can be enabled or disabled on a per program, per site, or both per program and per site basis. In addition, if the check for double booking is enabled, an instructor can select one of three options for the check. The first option is that all students can have overlapping shifts and no alerts are provided to the instructor. The second option is that all students can have overlapping shifts but the instructor is provided an alert. The third option is that no students can have overlapping shifts.

If the instructor decides to remove a student(s) from a shift, the instructor selects the student(s) to remove at 630. At 632, the instructor verifies which students are to be removed from the shift. At 634, assign students subcomponent 210 removes the student assignments from the shift. At 636, assign students subcomponent 210 adds the shift to the schedule of available shifts. At 638, assign students subcomponent 210 sends an email notification to the addressees in the email notification list regarding the addition or removal of students assigned to the shift.

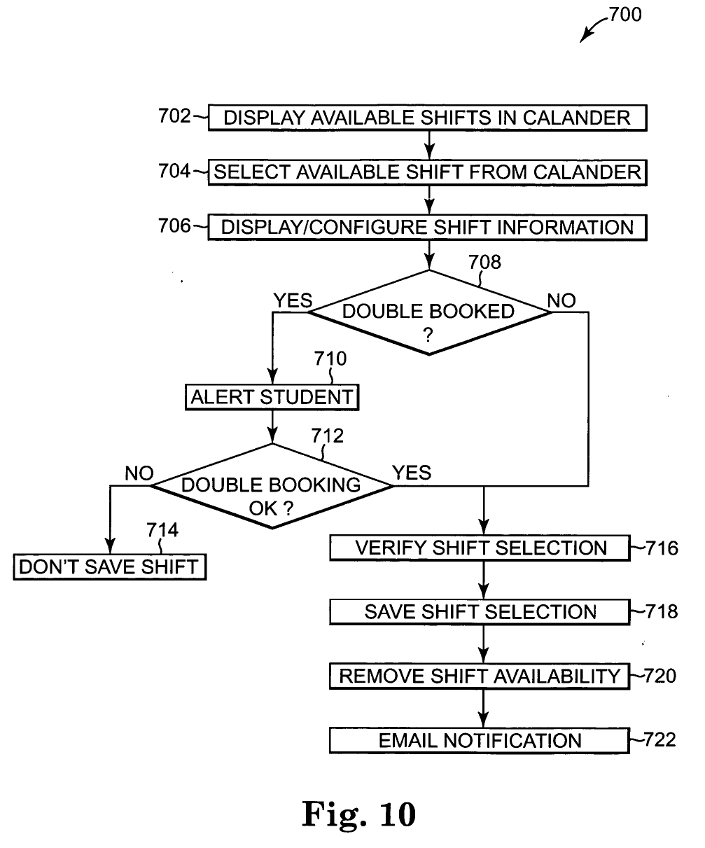

FIG. 10 is a flow diagram illustrating one embodiment of a method 700 for a student selecting a shift. In one embodiment, method 700 is part of, or performed by, student select shifts subcomponent 212 (FIG. 4). At 702, scheduling component 202 (FIG. 4) displays the available shifts in calendar 318 (FIG. 6). At 704, the student selects an available shift from calendar 318. At 706, student select shifts subcomponent 212 displays the shift information for confirmation by the student, including, for example, the shift start date, the shift start time, the shift duration, the shift site, the shift base, the shift preceptor, the number of open slots, the students signed up for the shift, notes, etc.

At 708, student select shifts subcomponent 212 checks whether the student is scheduled for more than one shift at the same time (i.e. double booked). If the student is double booked, the student is alerted at 710 and asked if the double booking is okay at 712. If the student answers that the double booking is not okay, then at 714 the shift selection is not saved in database 226. If the student answers at 712 that the double booking is okay or the student is not double booked at 708, then the student verifies the shift selection at 716.

In one embodiment, the check for double booking can be enabled or disabled on a per program, per site, or both per program and per site basis as previously described above with reference to FIG. 9.

At 718, student select shifts subcomponent 212 saves the shift selection to database 226 and a Shift Data Table 258 record is created or modified. At 720, student select shift subcomponent 212 removes the shift from the schedule of available shifts in calendar 318. At 722, student select shifts subcomponent 212 sends an email notification to the addressees in the email notification list regarding the addition or removal of students assigned to the shift.

The present invention provides a marked improvement over previous healthcare internship shift scheduling systems. In particular, the current invention provides a web based multi-institution, multi-program scheduling system that significantly simplifies the scheduling of healthcare internship shifts among many students and many healthcare institutions. In addition, programs can create shifts that can be shared with other programs. Instructors, students, and other authorized users have access to the multi-institution scheduler from any suitable computing device capable of connecting to the network. Schedules can be created, modified, and shared easily without the need for time consuming telephone calls, faxes, or mailings between the parties.

Although the embodiments of the present invention have been described with reference to scheduling healthcare internship shifts, it will be appreciated by those of ordinary skill in the art that multi-institution scheduling system 100 can be applied to the scheduling of shifts between multiple parties in any number of fields. For example, in other embodiments, multi-institution scheduling system 100 can be applied to janitorial services, nursing services, security services, contract employee services, etc.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A multi-institution scheduling system comprising:
an administration component adapted for establishing parameters for a first program in the multi-institution scheduling system, the parameters including at least one other program that can share shifts with the first program; and
a scheduling component adapted for creating a shift for the first program including designating whether the at least one other program has access to the shift for scheduling.

2. The multi-institution scheduling system of claim 1, wherein the scheduling component is adapted for specifying limitations for the shift.

3. The multi-institution scheduling system of claim 2, wherein the limitations comprise a class section.

4. The multi-institution scheduling system of claim 2, wherein the limitations comprise a student account type.

5. The multi-institution scheduling system of claim 1, wherein the parameters include at least one site associated with the first program.

6. The multi-institution scheduling system of claim 5, wherein the administration component is adapted to request approval from an administrator for the at least one associated site.

7. The multi-institution scheduling system of claim 5, wherein the scheduling component is adapted for selecting the at least one associated site for the shift.

8. The multi-institution scheduling system of claim 7, wherein the at least one associated site for the shift comprises one of a hospital, ambulance service, clinic, laboratory, and nursing home.

9. The multi-institution scheduling system of claim 1, wherein the scheduling component is adapted for creating the shift for the first program including specifying a start date for the shift and a date indicating when the shift will be available for scheduling.

10. The multi-institution scheduling system of claim 9, wherein the scheduling component is adapted to provide an alert if the start date and the date indicating when the shift will be available will result in the shift never being visible for scheduling.

11. The multi-institution scheduling system of claim 1, wherein the administration component and the scheduling component are computer implemented.

12. The multi-institution scheduling system of claim 11, wherein the administration component and the scheduling component each comprise a graphical user interface.

13. The multi-institution scheduling system of claim 1, wherein the scheduling component is adapted for editing the shift.

14. The multi-institution scheduling system of claim 1, wherein the scheduling component is adapted for deleting the shift.

15. The multi-institution scheduling system of claim 1, wherein the scheduling component is adapted for scheduling a student for the shift.

16. The multi-institution scheduling system of claim 15, wherein the scheduling component is adapted for scheduling the student for the shift by an instructor assigning the shift to the student.

17. The multi-institution scheduling system of claim 15, wherein the scheduling component is adapted for scheduling the student for the shift by the student selecting the shift.

18. The multi-institution scheduling system of claim 15, wherein the scheduling component is adapted to provide an alert if the student is double booked.

19. The multi-institution scheduling system of claim 15, wherein the scheduling component is adapted for allowing the student to drop the shift.

20. The multi-institution scheduling system of claim 15, wherein the scheduling component is adapted for allowing the student to trade the shift to another student.

21. The multi-institution scheduling system of claim 1, further comprising:
a skills tracking component for recording a student's proficiency of a skill performed during the shift.

22. The multi-institution scheduling system of claim 1, further comprising:
a reporting component for reporting information about the shift.

23. The multi-institution scheduling system of claim 1, further comprising:
a help component for providing instructions on using the administration component and the scheduling component.

24. The multi-institution scheduling system of claim 1, wherein the multi-institution scheduling system is for healthcare services students.

25. A multi-institution scheduling system comprising:
a computer system configured for executing a scheduling application, the application including:
an administration component adapted for establishing parameters for a first program in the multi-institution scheduling system, the parameters including at least one site and at least one other program that can share shifts with the first program; and
a scheduling component adapted for creating a shift for the first program including selecting whether the at least one other program has access to the shift for scheduling;
a network communicatively coupled to the computer system; and
a computing device communicatively coupled to the network and configured for accessing the scheduling application.

26. The multi-institution scheduling system of claim 25, wherein the network comprises an Internet.

27. The multi-institution scheduling system of claim 25, wherein the computer system comprises a computer server.

28. The multi-institution scheduling system of claim 27, wherein the computer server comprises a web server.

29. The multi-institution scheduling system of claim 25, wherein the scheduling component comprises a graphical user interface.

30. The multi-institution scheduling system of claim 29, wherein the graphical user interface comprises a webpage.

31. The multi-institution scheduling system of claim 25, wherein the administration component comprises a graphical user interface.

32. The multi-institution scheduling system of claim 25, wherein the computing device comprises a personal computer configured for executing a web browser application for accessing the scheduling application.

33. The multi-institution scheduling system of claim 25, wherein the multi-institution scheduling system is for healthcare services students.

34. A method for scheduling shifts, the method comprising:
establishing parameters for a first program in a multi-institution scheduling system, the parameters including a list of other programs associated with the first program; and
creating a shift for the first program including selecting other programs from the list of associated programs that have access to the shift for scheduling.

35. The method of claim 34, wherein establishing parameters for the first program includes establishing parameters including a list of sites associated with the first program.

36. The method of claim 35, wherein creating a shift includes selecting a site for the shift from the list of associated sites.

37. The method of claim 34, wherein creating the shift includes specifying minimum limitations for students that have access to the shift for scheduling.

38. The method of claim 37, further comprising:
specifying additional limitations above the minimum limitations for students of at least one of the associated programs that have access to the shift for scheduling.

39. The method of claim 37, wherein specifying the minimum limitations comprises specifying an account type of students.

40. The method of claim 34, further comprising scheduling a student for the shift.

41. The method of claim 40, wherein scheduling the student for the shift comprises an instructor assigning the student to the shift.

42. The method of claim 34, wherein scheduling the student for the shift comprises the student selecting the shift.

43. The method of claim 34, wherein the multi-institution scheduling system is for scheduling internship shifts for healthcare services students.

44. An article of manufacture comprising:
a computer readable medium bearing code embodied therein for a multi-institution scheduling system and including:
a first computer readable code segment for an administration component adapted for establishing parameters for a first program in the multi-institution scheduling system, the parameters including at least one other program that can share shifts with the first program; and
a second computer readable code segment for a scheduling component adapted for creating a shift for the first program including designating whether the at least one other program has access to the shift for scheduling.
